(19) United States
(12) Patent Application Publication
(10) Pub. No.: US 2007/0138081 A1
(43) Pub. Date: Jun. 21, 2007

(54) Portable Water Purification and Decontamination System

(76) Inventor: Mike Rice, Brady, TX (US)

Correspondence Address: TIM COOK, P.O. BOX 10107, LIBERTY, TX, 77575, US

(21) Appl. No.: 11/554,295

(22) Filed: Oct. 30, 2006

Related U.S. Application Data
(60) Provisional application No. 60/596,905, filed on Oct. 28, 2005.

(51) Int. Cl. C02F 9/00

(52) U.S. Cl. 210/257.2; 210/258; 210/266

(57) ABSTRACT

A vehicle mountable system adapted to purify contaminated water is provided. The system is supported on a surrounding frame for ease of transport from a storage facility to the bed of a production truck, and all electrical power required for operation of the system is included with the unit. Further, the system provides a heating recirculation feature so that the unit continues to function at temperatures below the freezing point. The system may also be aligned for a closed system, wherein water is taken from a storage tank, pumped into a decontamination enclosure, and recycled back to the storage tank after purification within the system. The system is also provided with a small standby pump to circulate water throughout the system and a plurality of heater elements to keep the system ready for immediate deployment during cold weather.

### FIELD OF THE INVENTION

The present invention relates generally to the field of portable purification systems, and, more particularly, to a truck mountable system which is adapted to take a suction from of source of water of unknown or impure quality and make pure water for unrestricted use. The present invention is particularly adapted for pumping water from a natural source of water such as a lake or a river to make unlimited quantities of water available for such purposes as decontamination. Alternatively, the present system provides a closed system for decontamination purposes, recycling water which has become contaminated through the purification system for re-use.

### BACKGROUND OF THE INVENTION

After a natural disaster has disrupted, severely damaged, or destroyed the physical infrastructure of a village or town, waterborne diseases often present the greatest risk to human health. This happens in both developed and developing world settings. Water supplies in these situations may be biologically contaminated by sewage effluents that mix with floodwaters, or physically contaminated with mud and soil that enter the water supply and hinder disinfection efforts. Harmful chemicals (e.g., nitrates and pesticides) are also typically found in flood water under such conditions, in addition to waterborne pathogens.

Contaminated water may be characterized as having a “biological load” and a “physical load.” The biological load of the water refers to the level of biological contaminants in the water. The physical load of the water refers to the total level of suspended solids, dissolved solids, organic carbon, and turbidity in the water.

It is sometimes desirable to disinfect contaminated water for drinking and other uses, such as decontamination. For example, after a natural disaster, a region's water supply may be compromised, necessitating emergency water treatment. It has long been known to disinfect water by exposing it to ultraviolet (“UV”) light, which kills contaminants in the water. In fact, disinfection devices that utilize UV light for purifying water have been used since the early 1900's. Typically, the “UV light disinfection unit” or device is configured to receive a stream of water. The device normally includes a UV light exposure chamber, through which the stream flows and is purified by exposure to a UV lamp. An exemplary UV light disinfection device is described in U.S. Pat. No. 5,780,860 to Gadgil et al. (“Gadgil '860”), which is hereby incorporated herein by reference, in its entirety.

Most UV light disinfection devices are designed for purification of water having a relatively low physical load. In order to treat water having a larger physical load, some water treatment units combine the UV light disinfection device with one or more filters for removal of particles from the water. Unfortunately, the filters tend to clog over time, and must be replaced periodically.

In U.S. Pat. No. 6,464,884 (Gadgil '884), Gadgil described a portable water treatment unit. That unit purifies contaminated water so that it is safe for drinking and other uses. The treatment unit removes biological and physical contaminants from water by solid separators, filters, and UV disinfection. A solid separator, such as a hydrocyclone, removes larger particles from the water, such as silt and sand. The filters generally remove smaller particles. The use of the solid separator(s) reduces the tendency of the filters to become clogged. A pump helps to force water through the solid separator and filters. A UV light disinfection unit is provided downstream of the filters. For ease of transportation, some or all of the treatment unit components may be provided in or on a cart with wheels.

Unfortunately, the Gadgil units are severely limited in that they rely on UV light disinfection, which is relatively slow to perform the desired purification effect. Further, the unit as taught by Gadgil is mounted in or on a cart with wheels, which limits its mobility and therefore its usefulness. Also, the Gadgil units are not adapted to cold weather, and are thus inapplicable to some of the very situations for which such water purification systems are most needed. Finally, in today's political world, one must also be concerned about nuclear contamination of the water supply, and nothing in either of the Gadgil units addresses the need of decontamination of personnel with pure water. The present invention is directed to correcting these and other significant limitations in the art.

### SUMMARY OF THE INVENTION

The present invention provides a vehicle mountable system adapted to purify contaminated water. The system is supported on a surrounding frame for ease of transport from a storage facility to the bed of a production truck, and all electrical power and gas heat fuel required for operation of the system is included with the unit. Further, the system provides a heating recirculation feature so that the unit continues to function at temperatures below the freezing point.

In a first aspect of the invention, a suction line with a strainer may be positioned in a source of water of dubious purity. A first, high volume pump, takes a suction on the hose or suction line extending from the strainer to the inlet to the high volume pump. The high volume pump discharges to a manifold, which directs the discharge of the high volume pump to a large capacity storage tank, or to a recirculation line including the purification elements of the system.

A set of pre-filters provides an initial cleaning of the physical load of the inlet water. The prefilters preferably comprise a 50 micron bag filter, a 20 micron wound filter, and a 5 micron wound filter. From the prefilters, the water is directed to a bank of mixed media filters, preferably configured in a series of four tanks. For greater volumetric flow, another series of four tanks may be arranged in parallel, or even more sets of filters, if desired. Following the mixed media filter bank, a 0.035 micron filter is provided, for removal of the finest physical contaminants.

From the mixed media filter bank and the 0.035μ filter, the water passes to a second pump, in this case a high pressure pump. This second pump forces the water through a reverse osmosis unit then into the high capacity storage tank. From the reverse osmosis unit, the water may also be directed to a reverse osmosis storage unit and into a manifold. The manifold may direct water through an on-demand water heater and thence to a hot water supply line, or directly into a cold water supply line. Purified hot and cold water are thus available. This water may also be directed to a decontamination shower. A third pump, i.e. a heating, recirculation pump may be directed to take a suction from a drain line on the high capacity storage tank and force water at low volume through the high volume pump, to keep the system warm in cold weather. The heating, recirculation pump is thermostat operated so that at a predetermined low temperature, the pump is actuated, recirculating heated water through the purification cycle and back to the storage tank, shutting off with a predetermined high temperature is reached.

A fourth pump is also provided for maintaining the system in a heated, ready condition while in storage. This fourth pump is operated from a standard, 110v outlet and provides low volume, low head flow throughout the system, particularly while the system is stored in an unheated warehouse. In this way, the system may be stored for long periods of time in a ready condition, without the need to keep the warehouse heated which is often too expensive.

In a further aspect of the invention, a self contained, closed system purification system for decontamination is provided. A large capacity storage tank provides a source of water, which is pumped to a decontamination enclosure. The water used for decontamination is gathered and recycled through the system and back to the storage tank. The system is capable of restoring lost water from a clean or a contaminated source, and with adequate fuel is thus able to operate substantially indefinitely.

These and other features and advantages of this invention will be readily apparent to those skilled in the art.

### BRIEF DESCRIPTION OF THE DRAWINGS

So that the manner in which the above recited features, advantages and objects of the present invention are attained and can be understood in detail, more particular description of the invention, briefly summarized above, may be had by reference to embodiments thereof which are illustrated in the appended drawings.

FIG. 1 is an overall schematic diagram of the purification system of the invention.

FIG. 2 is a side elevation view, illustrating how the various components of the system of packaged into a compact package within a metal framework so that the system can be mounted on a production truck.

FIG. 3A is an end elevation view of a decontamination enclosure supplied from the purification system of this invention. FIG. 3B is a side elevation view of the decontamination enclosure of FIG. 3A.

### DETAILED DESCRIPTION OF A PREFERRED EMBODIMENT

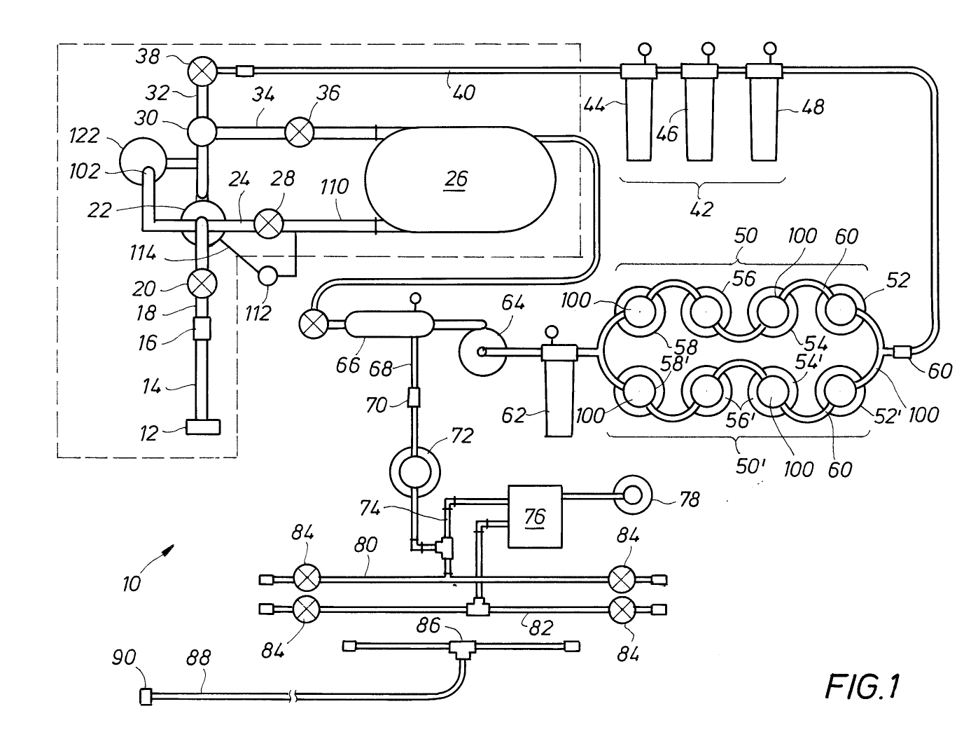

FIG. 1 depicts an overall schematic diagram of the portable purification system 10 of the present invention. This system is particularly adapted to be held in storage as a complete, stand-alone unit, and when the need arises, it is ready for loading onto the back of a pickup and deployed where required. The system 10 includes an inlet strainer 12 which strains out the largest debris before it enters the system. The strainer 12 is joined to a fill line 14, which is preferably a flexible re-enforced hose which may be joined together in 15 feet-long lengths to extend from the system 10 to a source of water for purification, such as a pond, lake, river, or the like. The fill line 14, whether one or more lengths of hose coupled together, terminates in a quick disconnect 16, in a preferred embodiment a 2 inch quick disconnect. This feature of the invention is particularly advantageous, since the fill line can thus be disconnected for storage on the transport vehicle, and connected on the scene.

The quick disconnect 16 extends to a pump inlet line 18 which includes a shutoff valve 20, preferably a 2 inch ball valve. The valve 20 may be used to isolate the suction inlet to a first pump 22, which is preferably a high volume, centrifugal pump capable of delivering high volumes of possibly contaminated water to the system 10 for purification, at relatively low discharge head. The pump 22 also includes an inlet line 24 from a high capacity storage tank 26 through a shutoff valve 28, which is also preferably a 2″ ball valve.

The pump 22 discharges into a discharge manifold 30 which directs fluid for purification into a purification supply line 32. Alternatively, if the water has already been through the purification system 10, the manifold 30 may be aligned to direct the water to the storage tank 26 by way of a storage tank supply line 34 which also includes a shutoff valve 36, preferably a 2″ ball valve.

The purification supply line 32 includes a shutoff valve 38, preferably a 1″ ball valve, which connects to a line 40. The line 40 provides water which may require purification to a bank of filters 42, which bank includes filters 44, 46, and 48. The filter 44 is preferably a 50μ bag filter, and filters 46 and 48 are preferably 20μ and 5μ wound filters, respectively, in progressively decreasing pore size for finer and finer filtration.

Once the water has passed through the filter bank 42, it is directed to an array of mixed media filters 50. As shown in FIG. 1, the components of the filter array 50 may be ganged together in series/parallel combination, as desired to accommodate the particular environment in which the purification system is to find application. The filtered water first enters a tank 52, which preferably comprises an 80% amine treated clay and 20% manganese dioxide. The water then passes to a tank 54 which preferably comprises an oxidation/reduction unit having an 80% pesticidal device and 20% sand. Next, a tank 56 includes a 35% strong acid cation resin and a 65% strong base anion resin. Finally, the water passes through a tank 58, which includes a 90% highly active acid washed carbon and a 10% crushed marble.

A similar array 50′ may also be included, comprising tanks 52′, 54′, 56′, and 58′, inclusive, which contain the same mixed media as the filter array 50. If the water to be purified includes a heavy ionic load, such as brine or seawater, the arrays 50 and 50′ may be coupled in series, for a total of eight tanks (or more) in series. The tanks are coupled together with quick disconnects 60 into the array, and into and out of each tank, so that the alignment of the arrays can be reoriented quickly and easily without moving the tanks. Each series combination of four tanks in the array is capable of five gallons per minute flow rate from fresh water. Multiple banks may be used to obtain the desired flow. A post 0.035μ wound filter 62 is provided after tank 58.

The water then passes from the filter 62 to the suction of a relatively low volume, high pressure pump 64. Discharge from the pump 64 is directed to a reverse osmosis unit 66. The reverse osmosis unit includes a semi-permeable membrane that blocks the transport of salts or other solutes through it. Osmosis is a fundamental effect in all biological systems. It is applied to water purification and desalination, waste material treatment, and many other chemical and biochemical laboratory and industrial processes. When two water (or other solvent) volumes are separated by a semi permeable membrane, water will flow from the side of low solute concentration, to the side of high solute concentration. The flow may be stopped, or even reversed by applying external pressure on the side of higher concentration, as from the pump 64 to develop the reverse osmosis. The water is thus purified, and is then directed to the tank 26 for storage, or to a supply line 68 for immediate use.

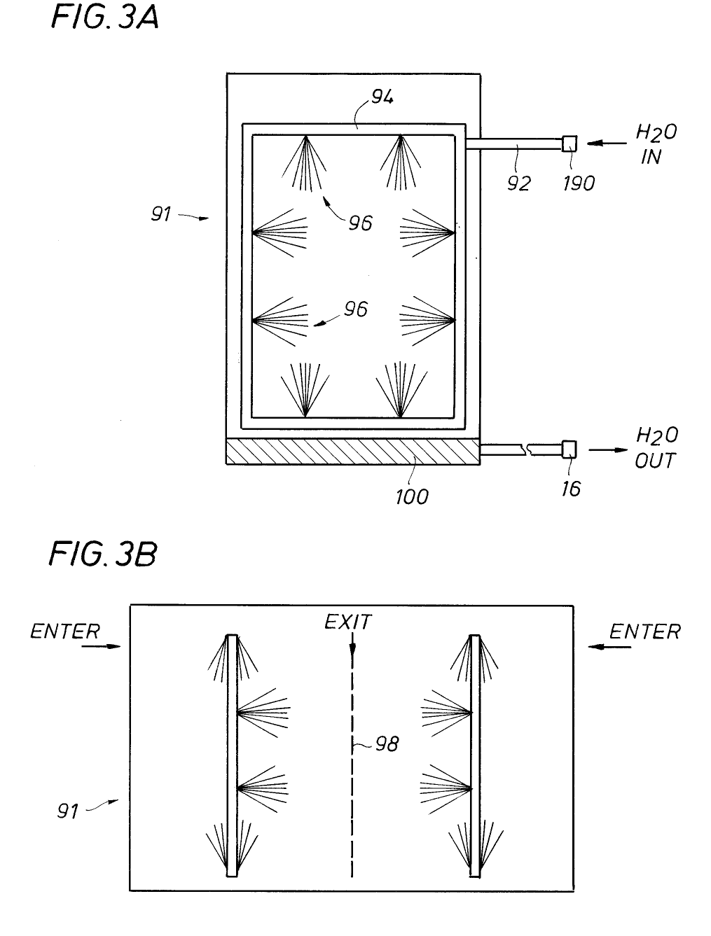

Purified water from the supply line 68 passes through a pressure valve 70 to a reverse osmosis (R.O.) storage tank 72. From the R.O. storage tank 72, the water passes to a manifold 74, which directs the water to an on-demand water heater 76, heated from a propane tank 78, or directly to a cold water supply line 80. Heated water from the heater 76 is directed to a hot water supply line 82. Each of the lines 80 and 82 is provided with a shutoff valve 84 to isolate the line so that the water is available for use. Alternatively, the water may be directed into a decontamination manifold 86 which may supply water to a decontamination shower, as shown and described below in respect of FIG. 3A and FIG. 3B.

The system 10 also includes a small, internally heated pump 112 which couples to a drain line 110 of the storage tank 26 and discharges through a discharge line 114 into the pump 22. In cold weather, the pump is thermostat activated to take a suction from the tank 26 and pump water heated by the pump 112 through the pump 22 and back to the tank 26 through the manifold 30. The valves may also be arranged to pump the heated water through the purification system, including the filter bank 42 and the filter array 50, to keep these components warm also. The thermostat preferably activates the pump 112 at 32° F. and shuts it off at 40° F., or any other temperature range as desired.

The system 10 also includes another pump 122 which is preferably a low volume, low head pump. This pump is run off a 110 vac source that the system 10 can simply plug into while the unit is in storage awaiting the need for its deployment. As shown in FIG. 1, the pump 122 takes a suction from the drain line 24, the same line that the pump 22 is lined up to, and discharges into the line downstream of the pump 22. Thus, the pump 122 is coupled in parallel with the pump 22, but is much smaller and more economical to run in a storage configuration. The pump 122 circulates water throughout the system 10 during cold storage conditions to keep the system thawed out and ready to use.

To assist in keeping the system 10 thawed out, the system includes a number of small heater elements distributed throughout the system. For example, each of the units in the filter array 50 includes a “dip stick” type heater element 130, which is long and thin to fit down into its respective tank. A heater element, such as for example a heat tape type element, is provided at the drain line from the tank 26, so that the water in the system is increased in temperature prior to being pumped by the pump 122. Each of the heater elements 130 and 132, and other which may be provided as required, are also energized from the 110vac outlet so that the system 10 is properly maintained in a standby condition.

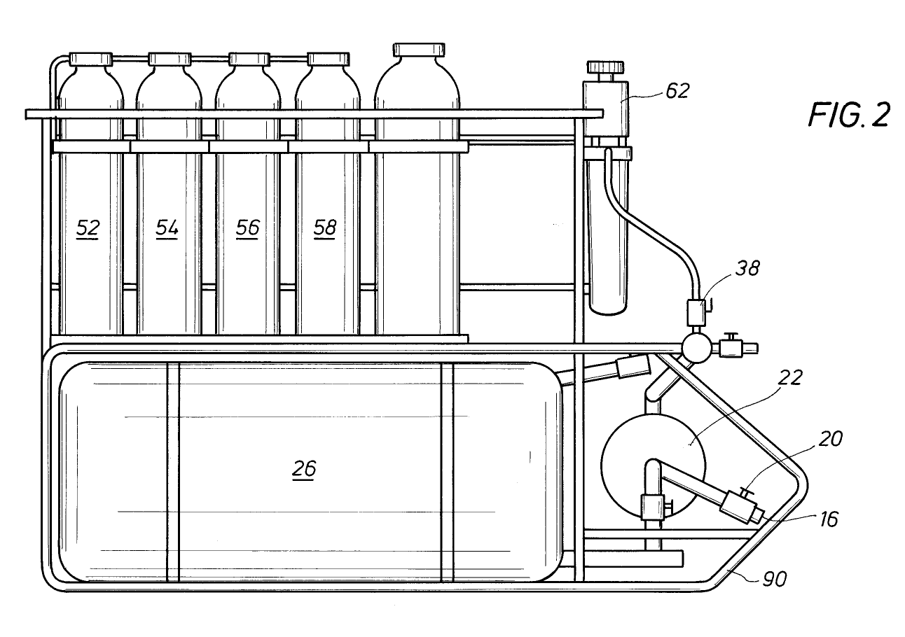

Another significant advantage of the present invention is that all of the components just described in respect of FIG. 1 are packaged into a compact arrangement so that the system 10 can be separately stored and then mounted on the bed of a pickup, as shown in FIG. 2. The system 10 is enclosed within a sturdy framework 90, preferably made of tubular metal or high strength plastic, which supports all of the various components. The framework 90 also serves as the lifting structure, to permit lifting the system onto and off of the bed of a pickup.

FIGS. 3A and 3B depict a decontamination enclosure 91 wherein the present invention finds application. A quick disconnect 190 (see also FIG. 1) connects the system 10 to a supply line 92. The enclosure includes a plurality of pipes 94 pressurized by the supply line 92 to develop spray jets 96 from all directions on personnel within the enclosure 91. Preferably, personnel enter through a zippered access (not shown) and exit through a zippered exit 98. This aspect keeps as much contamination as possible within the enclosure. The spray is directed onto contaminated personnel, and falls through a grating on the floor, where it is captured in a catch basin 100. A suction line 102 connects to the catch basin 100, and terminates in the quick disconnect 16 at the suction of the high velocity pump 22. When taking a suction on the catch basin 100, the suction line preferably includes a bypass line to avoid sucking the basin dry and thereby sucking air through the pump. With this aspect of the invention, the system 10 provides a closed system, with only occasional makeup for lost water required.

The principles, preferred embodiment, and mode of operation of the present invention have been described in the foregoing specification. This invention is not to be construed as limited to the particular forms disclosed, since these are regarded as illustrative rather than restrictive. Moreover, variations and changes may be made by those skilled in the art without departing from the spirit of the invention.

I claim:

1. A portable water purification system comprising:
a. an inlet for introducing water into the system;
b. a first pump coupled to the inlet and developing flow of the water through the system at an outlet of the pump;
c. a storage tank coupled to the outlet of the pump;
d. a series of filters at the outlet of the pump;
e. an array of mixed media filtration tanks joined to the series of filters; and
f. a reverse osmosis unit joined to the mixed media filtration tanks, and to the storage tank at an outlet of the reverse osmosis unit.

2. The system of claim 1, further comprising an inlet strainer coupled to the inlet.

3. The system of claim 1, wherein the inlet comprises a plurality of lengths of hose.

4. The system of claim 1, wherein the series of filters comprises a 50μ bag filter coupled in series with a 20μ wound filter coupled in series with a 5μ wound filter.

5. The system of claim 1, wherein the array of mixed media filtration tanks includes a plurality of pipes and disconnects, wherein the array may be arranged in a user configurable series and parallel combination of tanks.

6. The system of claim 1, further comprising a low head, low capacity pump in parallel with the first pump.

7. The system of claim 1, further comprising a plurality of heating elements in the system to maintain the system in a ready condition.

8. The system of claim 1, further comprising a reverse osmosis storage tank at the outlet of the reverse osmosis unit, wherein the reverse osmosis storage tank includes an outlet.

9. The system of claim 8, further comprising an on-demand heating unit at the outlet of the reverse osmosis storage tank.

10. The system of claim 9, further comprising:
a. a cold water supply line coupled to the reverse osmosis storage tank outlet; and
b. a hot water supply line coupled to the on-demand heating unit.

11. The system of claim 10, further comprising a decontamination tent supplied from the cold water supply line and the hot water supply line.
